(19) United States
(12) Patent Application Publication
(10) Pub. No.: US 2011/0235219 A1
(43) Pub. Date: Sep. 29, 2011

(54) PROTECTING DEVICE

(75) Inventor: YONG-ZHAO HUANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/768,560

(22) Filed: Apr. 27, 2010

(30) Foreign Application Priority Data
Mar. 25, 2010 (CN) 201010132381.0

(51) Int. Cl. H02H 5/00

(52) U.S. Cl. 361/18

(57) ABSTRACT

A protecting device includes a power plug, a switch circuit, and a power supply circuit. The switch circuit is connected to the power plug. The power supply circuit is connected to the switch circuit and the power plug. When the temperature of the protecting device is higher than a predetermined temperature, a voltage at a node between a thermo-sensor and a variable resistor is higher than a turn-on voltage of a second electrical switch to turn on the second electrical switch, a first electrical switch is turned off, the power supply circuit is disconnected from the power plug to stop the electronic device from working.

### BACKGROUND

1. Technical Field

The present disclosure relates to protecting devices and, particularly, to a protecting device which can prevent an electronic device from being damaged by overheating.

2. Description of Related Art

Nowadays, when an electronic device works for long periods, overheating can occur. This overheating can damage or destroy the electronic device.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a circuit diagram of a first exemplary embodiment of a protecting device.

FIG. 2 is a circuit diagram of a second exemplary embodiment of the protecting device.

FIG. 3 is a circuit diagram of a third exemplary embodiment of the protecting device.

### DETAILED DESCRIPTION

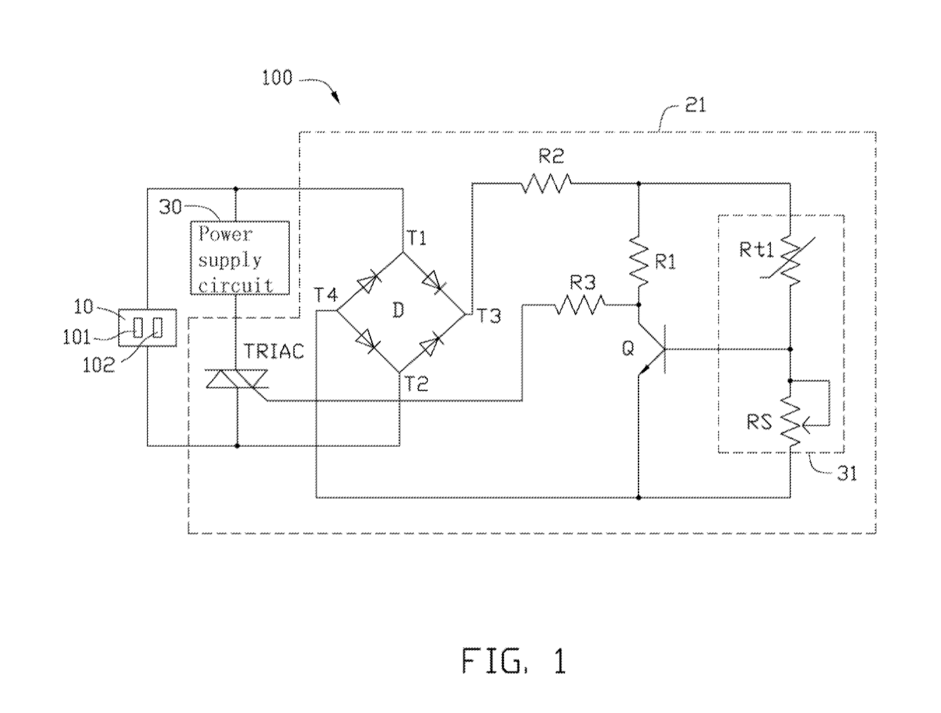

Referring to FIG. 1, a first exemplary embodiment of a protecting device 100 is arranged in an electronic device (not shown) to prevent the electronic device overheating and includes a power plug 10, a switch circuit 21 connected to the power plug 10, and a power supply circuit 30 connected to the switch circuit 21 and the power plug 10. The power supply circuit 30 is used for powering the electronic device.

The switch circuit 21 includes a first electrical switch, a bridge rectifier D, a variable resistor RS, a thermo-sensor, a second electrical switch, and resistors R1-R3. In the embodiment, the first electrical switch is a bidirectional triode thyristor TRIAC. The second electrical switch is a transistor Q. The thermo-sensor is a heat-variable resistor Rt1. The resistance of the heat-variable resistor Rt1 increases with decreasing of the temperature of the heat-variable resistor Rt1 and decreases with increasing of the temperature of the heat-variable resistor Rt1. A first terminal 101 of the power plug 10 is connected to a first main electrode of the bidirectional triode thyristor TRIAC via the power supply circuit 30. A second main electrode of the bidirectional triode thyristor TRIAC is connected to a second terminal 102 of the power plug 10. Two input terminals T1, T2 of the bridge rectifier D are connected to the first and second terminals 101 and 102 of the power plug 10 respectively. The heat-variable resistor Rt1 and the variable resistor RS are connected in series to form a voltage dividing circuit 31. A first terminal of the voltage dividing circuit 31 is connected to a first output terminal T3 of the bridge rectifier D via the resistor R2. A second terminal of the voltage dividing circuit 31 is connected to a second output terminal T4 of the bridge rectifier D. A base of the transistor Q is connected to a node between the heat-variable resistor Rt1 and the variable resistor RS. An emitter of the transistor Q is connected to the first output terminal T4 of the bridge rectifier D. A collector of the transistor Q is connected to a node between the heat-variable resistor Rt1 and the resistor R2 via the resistor R1. The collector of the transistor Q is also connected to a control terminal of the bidirectional triode thyristor TRIAC via the resistor R3. When the control terminal of the bidirectional triode thyristor TRIAC receives a trigger signal, the bidirectional triode thyristor TRIAC is turned on. When the control terminal of the bidirectional triode thyristor TRIAC fails to receive the trigger signal, the bidirectional triode thyristor TRIAC is turned off. The first terminal of the bidirectional triode thyristor TRIAC is a first main electrode. The second terminal of the bidirectional triode thyristor TRIAC is a second main electrode.

When the power plug 10 is inserted into a power socket, an alternating current (AC) voltage is received and supplied to the power supply circuit 30 to power the electronic device. The bridge rectifier D converts the AC voltage from the power plug 10 into the DC voltage. When the temperature of the electronic device 100 is lower than a predetermined value (E.g. 40 degrees Celsius), a voltage at the node between the heat-variable resistor Rt1 and the variable resistor RS is lower than the turn-on voltage of the transistor Q. The transistor Q is turned off and the bidirectional triode thyristor TRIAC is turned on. The power supply circuit 30 is connected to the power plug 10 to power the electronic device 100. When the temperature of the electronic device 100 reaches the predetermined value (E.g. 40 degrees Celsius), the voltage at the node between the heat-variable resistor Rt1 and the variable resistor RS is higher than the turn-on voltage of the transistor Q. The transistor Q is turned on and the bidirectional triode thyristor TRIAC is turned off. The power supply circuit 30 is disconnected from the power plug 10 to stop powering the electronic device 100.

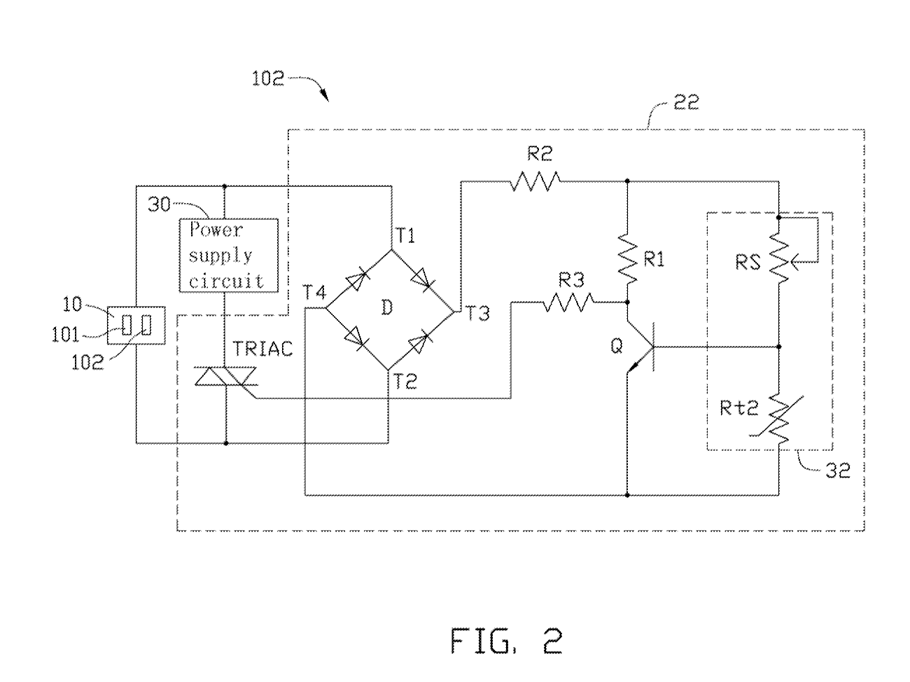

Referring to FIG. 2, a second embodiment of the protecting device 102 is similar to the first embodiment of the protecting device 100, except for the voltage dividing circuit 31. In the second embodiment, the voltage dividing circuit 32 includes the variable resistor RS and a heat-variable resistor Rt2 connected in series. The variable resistor RS is connected between the base of the transistor Q and the node between the resistor R1 and resistor R2. The heat-variable resistor Rt2 is connected between the emitter and the base of the transistor Q. The resistance of the heat-variable resistor Rt2 decreases with increasing of the temperature of the heat-variable resistor Rt2, and increases with decreasing of the temperature of the heat-variable resistor Rt2.

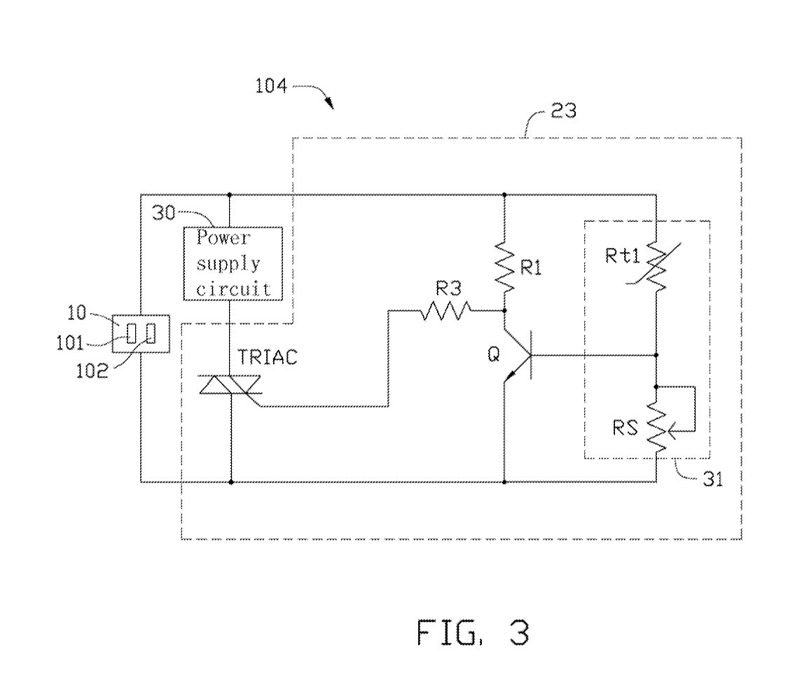

Referring to FIG. 3, a third embodiment of the protecting device 104 is similar to the first embodiment of the protecting device 100. In the third embodiment, the bridge rectifier D and the resistor R2 are omitted. The base of the transistor Q is connected to the node between the heat-variable resistor Rt1 and the variable resistor RS. The collector of the transistor Q is connected to the first terminal 101 of the power plug 10 via the resistor R1. The collector of the transistor Q is also connected to the control terminal of the bidirectional triode thyristor TRIAC via the resistor R3. The emitter of the transistor Q is connected to the second terminal 102 of the power plug 10. The variable resistor RS and the heat-variable resistor Rt1 are connected in series between the first and second terminals 101 and 102 of the power plug 10.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A protecting device comprising:
a power plug to receive an alternating current (AC) voltage, the power plug comprising a first terminal and a second terminal;
a power supply circuit connected to the power plug to receive the AC voltage to power the electronic device;
a switch circuit connected to the power supply circuit and the power plug, the switch circuit comprising:
a rectifier to convert the AC voltage from the power plug into a direct current (DC) voltage, the rectifier comprising a first input terminal connected to the first terminal of the power plug, a second input terminal connected to the second terminal of the power plug, and first and second output terminals;
a first electrical switch comprising a first terminal connected to the first terminal of the power plug via the power supply circuit, a second terminal connected to the second terminal of the power plug, and a control terminal;
a second electrical switch comprising a first terminal connected to the control terminal of the first electrical switch via a first resistor and the first output terminal of the rectifier via a second resistor, a second terminal connected to the second output terminal of the rectifier, and a control terminal;
a thermo-sensor to sense a temperature of the electronic device to change a resistance thereof;
a variable resistor connected to the thermo-sensor in series between the first and second output terminal of the rectifier, wherein a node between the variable resistor and the thermo-sensor connected to the control terminal of the second electrical switch;
wherein when the temperature of the electronic device is higher than a predetermined temperature, a voltage at the node between the thermo-sensor and the variable resistor is higher than a turn-on voltage of the second electrical switch to turn on the second electrical switch, the first electrical switch is turned off, the power supply circuit is disconnected from the power plug to stop the electronic device.

2. The protecting device of claim 1, wherein when the temperature of the electronic device is lower than the predetermined temperature, the voltage at the node between the thermo-sensor and the variable resistor is lower than the turn-on voltage of the second electrical switch to turn off the second electrical switch, the first electrical switch is turned on, the power supply circuit is connected to the power plug to power the electronic device.

3. The protecting device of claim 1, wherein the thermo-sensor is a heat-variable resistor, a resistance of the thermo-sensor decreases with increasing of the temperature of the electronic device, and the resistance of the thermo-sensor increases with decreasing of the temperature of the electronic device, the heat-variable resistor is connected between the first terminal and control terminal of the second electrical switch, the variable resistor is connected between the second terminal and control terminal of the second electronic device.

4. The protecting device of claim 1, wherein the thermo-sensor is a heat-variable resistor, a resistance of the thermo-sensor increases with increasing of the temperature of the electronic device, and the resistance of the thermo-sensor decreases with decreasing of the temperature of the electronic device, the heat-variable resistor is connected between the second terminal and control terminal of the second electrical switch, the variable resistor is connected between the first terminal and control terminal of the second electronic device.

5. The protecting device of claim 1, wherein the first electrical switch is a bidirectional triode thyristor, the first terminal of the first electrical switch is a first main electrode of the bidirectional triode thyristor, the second terminal of the first electrical switch is a second main electrode of the bidirectional triode thyristor, the second electrical switch is a transistor, the first terminal of the second electrical switch is a collector of the transistor, the second terminal of the second electrical switch is an emitter of the transistor, the control terminal of the second electrical switch is a base of the transistor.

6. A protecting device comprising:
a power plug to receive a direct current (DC) voltage, the power plug comprising a first terminal and a second terminal;
a power supply circuit connected to the power plug to receive DC voltage to power the electronic device;
a switch circuit connected to the power supply circuit and the power plug, the switch circuit comprising:
a first electrical switch comprising a first terminal connected to the first terminal of the power plug via the power supply circuit, a second terminal connected to the second terminal of the power plug, and a control terminal;
a second electrical switch comprising a first terminal connected to the control terminal of the first electrical switch via a first resistor and the first terminal of the power plug via a second resistor, a second terminal connected to the second terminal of the power plug, and a control terminal;
a thermo-sensor to sense a temperature of the electronic device to change a resistance thereof;
a variable resistor connected to the thermo-sensor in series between the first terminal and second terminal of the second electrical switch, wherein a node between the variable resistor and the thermo-sensor connected to the control terminal of the second electrical switch;
wherein when the temperature of the electronic device is higher than a predetermined temperature, a voltage at the node between the thermo-sensor and the variable resistor is higher than a turn-on voltage of the second electrical switch to turn on the second electrical switch, the first electrical switch is turned off, the power supply circuit is disconnected from the power plug to stop powering the electronic device.

7. The protecting device of claim 6, wherein when the temperature of the electronic device is lower than the predetermined temperature, the voltage at the node between the thermo-sensor and the variable resistor is lower than the turn-on voltage of the second electrical switch to turn off the second electrical switch, the first electrical switch is turned on, the power supply circuit is connected to the power plug to power the electronic device.

8. The protecting device of claim 6, wherein the thermo-sensor is a heat-variable resistor, a resistance of the thermo-sensor decreases with increasing of the temperature of the electronic device, increases with decreasing of the temperature of the electronic device, the heat-variable resistor is connected between the first terminal and control terminal of the second electrical switch, the variable resistor is connected between the second terminal and control terminal of the second electronic device.

9. The protecting c device of claim 6, wherein the thermo-sensor is a heat-variable resistor, a resistance of the thermo-sensor increases with increasing of the temperature of the electronic device, decreases with decreasing of the temperature of the electronic device, the heat-variable resistor is connected between the second terminal and control terminal of the second electrical switch, the variable resistor is connected between the first terminal and control terminal of the second electronic device.

10. The protecting device of claim 6, wherein the first electrical switch is a bidirectional triode thyristor, the first terminal of the first electrical switch is a first main electrode of the bidirectional triode thyristor, the second terminal of the first electrical switch is a second main electrode of the bidirectional triode thyristor, the second electrical switch is a transistor, the first terminal of the second electrical switch is a collector of the transistor, the second terminal of the second electrical switch is an emitter of the transistor, the control terminal of the second electrical switch is a base of the transistor.
